(19) United States
(12) Patent Application Publication
(10) Pub. No.: US 2012/0324342 A1
(43) Pub. Date: Dec. 20, 2012

(54) Methods, Systems, and Computer Program Products for Generating a Media Presentation for Digital Signage

(75) Inventor: Robert Scott Donley, Raleigh, NC (US)

(73) Assignee: Mediplay, Inc.

(21) Appl. No.: 13/523,475

(22) Filed: Jun. 14, 2012

Related U.S. Application Data
(60) Provisional application No. 61/496,768, filed on Jun. 14, 2011.

(51) Int. Cl. G06F 17/00

(52) U.S. Cl. 715/246

(57) ABSTRACT

A method of generating a media presentation includes receiving a request to create a template, the template comprising a page, receiving a selection of a layout from a plurality of layouts for the page, the layout specifying positions of display windows on the page, and saving the template.

### RELATED APPLICATION

This application claims the benefit of and priority to U.S. Provisional Patent Application No. 61/496,768 filed Jun. 14, 2011, the disclosure of which is hereby incorporated herein by reference as if set forth in its entirety.

### FIELD OF THE INVENTION

The present invention relates to information sharing through digital signage, and, more particularly, to methods, systems, and computer program products for generating a media presentation for digital signage.

### BACKGROUND

Digital signage refers to a form of electronic display for presenting various types of media content, such as video, text, graphics, and the like. Digital signs can be displayed using a variety of different technologies to present their content and can be found in both public and private environments, such as retail stores, corporate offices, health care facilities, airports, hotels, restaurants, and the like.

Entities often use digital signage to advertise or convey information to visitors or customers. The information, advertisements, and/or messages may be displayed on digital signs in such a way so as to target information to particular locations and/or parties at specific times.

Win the field of digital signage, “content” refers to anything designed to be displayed on a screen. Content can include any type of information or media type, such as text images, animations, video, audio, etc. Content design may be outsourced to a specialist in advertising, for example, or may be done internally by the party associated with the signage. Third party servers and software may be used to distribute the digital signage content to one or more displays, which may be co-located or spread apart geographically.

To enhance the effectiveness of digital signage, it is generally desirable to keep the content updated and fresh so that the information being conveyed is current and is targeted properly to the individuals the part associated with the signage desires to reach. Creating a design for the display, updating and changing the design, and writing/updating the content for the display can be expensive, however, when outsourced to an advertising agency and can be time consuming and technically difficult when done internally.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

According to some embodiments of the present invention, a method of generating a media presentation comprises receiving a request to create a template, the template comprising a page, receiving a selection of a layout from a plurality of layouts for the page, the layout specifying positions of display windows on the page, and saving the template.

In other embodiments, the page is a first page and the method further comprises receiving a request to add a second page to the template, receiving a selection of a layout from the plurality of layouts for the second page, and saving the template, which comprises the first and second pages.

In still other embodiments, the method further comprises receiving a selection of a transition type that specifies how a display transitions between displaying the first page and the second page.

In still other embodiments, the method further comprises defining a plurality of content zones for a display.

In still other embodiments, the plurality of content zones comprises a branding zone, a weather zone, a fader zone, a main zone, and a sidebar zone.

In still other embodiments, the template is associated with the main content zone on a display.

In still other embodiments, the template is associated with a sidebar content zone on a display.

In still other embodiments, the method further comprises receiving a selection of a saved template from a plurality of saved templates, adding content to the saved template to create an instantiated template, and saving the instantiated template.

In still other embodiments, adding content to the saved template comprises receiving the content from a user.

In still other embodiments, adding content to the saved template comprises receiving a selection of stored content.

In still other embodiments, the method further comprises publishing the instantiated template for presentation on at least one display.

In still other embodiments, publishing the instantiated template comprises receiving a selection of a frequency for which the instantiated template is presented on the at least one display.

In still other embodiments, saving the instantiated template comprises receiving sharing privileges for the instantiated template that indicates who can access the instantiated template.

In further embodiments of the present invention, a system for generating a media presentation comprises a processor configured to receive a request to create a template, the template comprising a page, receive a selection of a layout from a plurality of layouts for the page, the layout specifying positions of display windows on the page, and save the template.

In still further embodiments, the page is a first page, the processor being further configured to receive a request to add a second page to the template, receive a selection of a layout from the plurality of layouts for the second page, and save the template, which comprises the first and second pages.

In still further embodiments, the processor is further configured to receive a selection of a transition type that specifies how a display transitions between displaying the first page and the second page.

In still further embodiments, the processor is further configured to define a plurality of content zones for a display.

In still further embodiments, the plurality of content zones comprises a branding zone, a weather zone, a fader zone, a main zone, and a sidebar zone.

In still further embodiments, the template is associated with the main content zone on a display.

In still further embodiments, the template is associated with a sidebar content zone on a display.

In still further embodiments, the processor is further configured to receive a selection of a saved template from a plurality of saved templates, add content to the saved template to create an instantiated template, and save the instantiated template.

In still further embodiments, the processor is configured to add content to the saved template by receiving the content from a user.

In still further embodiments, the processor is configured to add content to the saved template by receiving a selection of stored content.

In still further embodiments, the processor is further configured to publish the instantiated template for presentation on at least one display.

In still further embodiments, the processor is configured to publish the instantiated template by receiving a selection of a frequency for which the instantiated template is presented on the at least one display.

In still further embodiments, the processor is configured to save the instantiated template by receiving sharing privileges for the instantiated template that indicates who can access the instantiated template.

In other embodiments, a computer program product for generating a media presentation comprises a non-transitory computer readable storage medium having computer readable program code embodied therein. The computer readable program code comprises computer readable program code configured to receive a request to create a template, the template comprising a page, computer readable program code configured to receive a selection of a layout from a plurality of layouts for the page, the layout specifying positions of display windows on the page, and computer readable program code configured to save the template.

In still other embodiments, the page is a first page, the computer readable program code further comprising computer readable program code configured to receive a request to add a second page to the template, computer readable program code configured to receive a selection of a layout from the plurality of layouts for the second page, and computer readable program code configured to save the template, which comprises the first and second pages.

In still other embodiments, the computer readable program code further comprises computer readable program code configured to receive a selection of a transition type that specifies how a display transitions between displaying the first page and the second page.

In still other embodiments, the computer readable program code further comprises computer readable program code configured to define a plurality of content zones for a display.

In still other embodiments, the plurality of content zones comprises a branding zone, a weather zone, a fader zone, a main zone, and a sidebar zone.

In still other embodiments, the template is associated with the main content zone on a display.

In still other embodiments, the template is associated with a sidebar content zone on a display.

In still other embodiments, the computer readable program code further comprises computer readable program code configured to receive a selection of a saved template from a plurality of saved templates, computer readable program code configured to add content to the saved template to create an instantiated template, and computer readable program code configured to save the instantiated template.

In still other embodiments, the computer readable program code configured to add content to the saved template comprises computer readable program code configured to receive the content from a user.

In still other embodiments, the computer readable program code configured to add content to the saved template comprises computer readable program code configured to receive a selection of stored content.

In still other embodiments, the computer readable program code further comprises computer readable program code configured to publish the instantiated template for presentation on at least one display.

In still other embodiments, the computer readable program code configured to publish the instantiated template comprises computer readable program code configured to receive a selection of a frequency for which the instantiated template is presented on the at least one display.

In still other embodiments, wherein the computer readable program code configured to save the instantiated template comprises computer readable program code configured to receive sharing privileges for the instantiated template that indicates who can access the instantiated template.

Other methods, systems, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a communication network for generating a media presentation for digital signage in accordance with some embodiments of the present invention;

FIG. 2 illustrates a software architecture that may be used in data processing systems for generating a media presentation for digital signage in accordance with some embodiments of the present invention;

FIG. 3 is a block diagram that illustrates a communication network for publishing a media presentation for digital signage in accordance with some embodiments of the present invention;

FIGS. 4-6 are flow diagrams that illustrate display elements for generating a media presentation for digital signage in accordance with some embodiments of the present invention;

FIG. 7 is a block diagram that illustrates a template for use in a media presentation for digital signage in accordance with some embodiments of the present invention;

FIG. 8 is a flowchart for creating a template for use in a media presentation for digital signage in accordance with some embodiments of the present invention; and

FIG. 9 is a flow diagram that illustrates adding content to a template to create an instantiated template and publishing the instantiated template in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present invention may be embodied as methods, systems, and/or computer program products. Accordingly, the present invention may be embodied in hardware and/or in software (including firmware, resident software, micro-code, etc.). Furthermore, the present invention may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described herein with respect to generating a media presentation for digital signage for a medical environment, such as a doctor's office. It will be understood that embodiments of the present invention are not limited to a particular type of digital signage environment, such as a medical environment, but may include, but are limited to, retail environments, restaurants, hotels, motels, public facilities, etc.

Some embodiments of the present invention stem from a realization that generating a media presentation for digital signage including the design of how the content is displayed as well as the content itself may be expensive when outsourcing the project to advertising professionals, for example, and may be technically complex to perform in-house. Some embodiments of the present invention provide a portal for generating a media presentation for digital signage that facilitates a methodology for designing a display layout for filling the display layout with content to convey information.

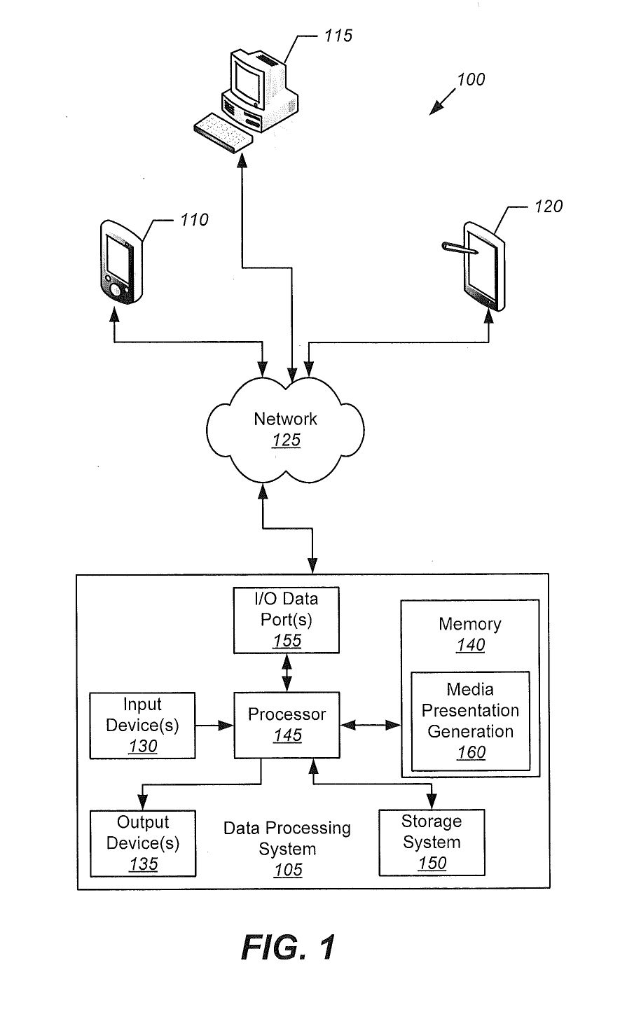

FIG. 1 is a block diagram that illustrates a communication network 100 for generating a media presentation for digital signage in accordance with some embodiments of the present invention. As shown in FIG. 1, the communication network 100 comprises a data processing system 105 that may be configured to facilitate the generation of media presentations by users for digital signage. The various users of the data processing system 105 are represented by the electronic devices 110, 115, 120. These devices may be any type of electronic device capable of establishing a communication connection with the data processing system 105. The communication connection may be a wireless and/or wireline connection over a communication network, such as network 125 or may be a direct, non-networked connection. In accordance with various embodiments, the network 125 may comprise, for example, the Internet, a wide area network, a local area network, and/or combinations of such networks.

The data processing system 105, in accordance with some embodiments of the present invention, comprises input device(s) 130, output devices 135, such as a display, and a memory 140 that communicate with a processor 145. The input devices 130 and the output devices 135 may comprise various peripheral devices, which include, but are not limited to, an identification card device, an electronic pen that may facilitate electronic signatures for documents, a display or screen, a scanner, a cash/credit acceptor, a keyboard, a mouse, a printer, a camera or other communication device that facilitates two-way live communication, and an audio speaker. The data processing system 105 may further comprise a storage system 150 and an I/O data port(s) 155 that also communicate with the processor 145. The storage system 150 may include removable and/or fixed media, such as floppy disks, ZIP drives, hard disks, or the like as well as virtual storage such as a RAMDISK. The I/O data port(s) 155 may be used to transfer information between the data processing system 105 and another computer system or a network (e.g., an Intranet and/or the Internet). These components may be conventional components, such as those used in many conventional computing devices, and their functionality, with respect to conventional operations, is generally known to those skilled in the art. In accordance with various embodiments of the present invention, the memory 140 may comprise a media presentation generation module 160 that may be configured to facilitate the ability of users to create media presentations for digital signage.

It will be appreciated that the data processing system 105 may be implemented as a single server, separate servers, or a network of servers either co-located in a server farm, for example, or located in different geographic regions.

Although FIG. 1 illustrates an exemplary communication network for generating a media presentation for digital signage in accordance with some embodiments of the present invention, it will be understood that the present invention is not limited to such a configuration but is intended to encompass any configuration capable of carrying out operations described herein.

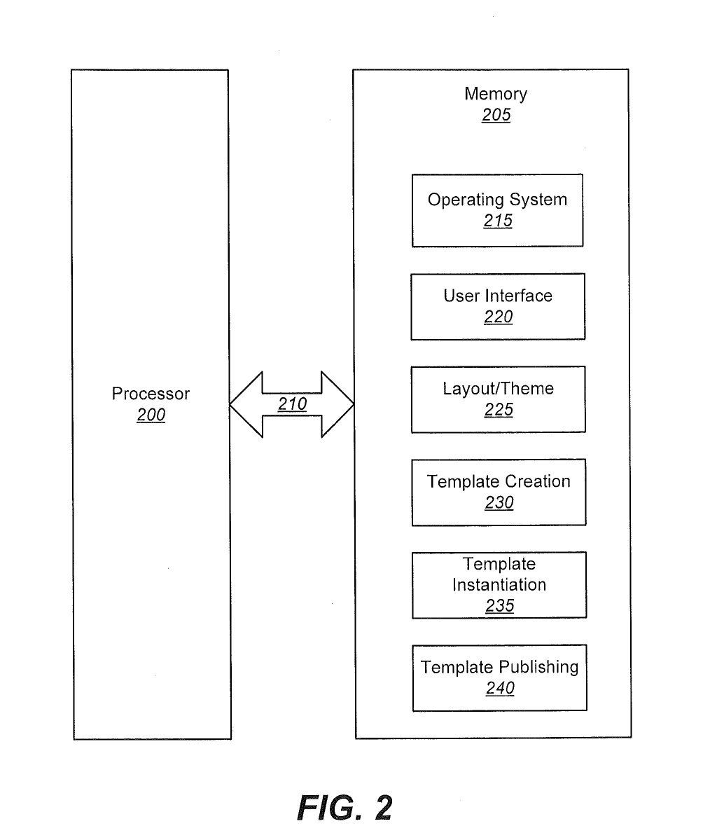

FIG. 2 illustrates a processor 200 and memory 205 that may be used in embodiments of data processing systems, such as the data processing system 105 of FIG. 1, for generating a media presentation for digital signage in accordance with some embodiments of the present invention. The functionality provided by the processor 200 and memory 205 may be accessed, for example, by a user through a Web browser to create presentations for digital signage according to some embodiments of the present invention. The processor 200 communicates with the memory 205 via an address/data bus 210. The processor 200 may be, for example, a commercially available or custom microprocessor. The memory 205 is representative of the one or more memory devices containing the software and data used to facilitate the creation of shared media pages in accordance with some embodiments of the present invention. The memory 205 may include, but is not limited to, the following types of devices: cache, ROM, PROM, EPROM, EEPROM, flash, SRAM, and DRAM.

As shown in FIG. 2, the memory 205 may contain up to six or more categories of software and/or data: an operating system 215, a user interface module 220, a display layout/theme infrastructure module 225, a template creation module 230, a template instantiation module 235, and a template publishing module 240. The operating system 215 generally controls the operation of the data processing system. In particular, the operating system 215 may manage the data processing system's software and/or hardware resources and may coordinate execution of programs by the processor 200.

The user interface module 220 may be configured to provide a portal via which users may access tools to generate a media presentation for digital signage. Such tools may include interfaces for creating templates that define how content is displayed and arranged on digital signage and also tools for populating the templates with actual content.

The display layout/theme infrastructure module 225 may be configured to provide various display elements, such as screen resolutions, themes, which include styles, display zone definitions, and the like.

The template creation module 230 may be configured to provide a methodology for generating a template that may include one or more pages that define the layout for particular zones on the display.

The template instantiation module 235 may be configured to allow a user to populate a template with content to create an instantiated template through either entering in custom content and/or selecting previously developed content made available on the media presentation generation system.

The template publishing module 240 may be configured to publish instantiated templates to a destination display platform through, for example, a digital signage distribution server.

Although FIG. 2 illustrates an exemplary software architecture that may be used in data processing systems, such as data processing system 105 of FIG. 1, for generating a media presentation for digital signage in accordance with some embodiments of the present invention, it will be understood that the present invention is not limited to such a configuration but is intended to encompass any configuration capable of carrying out operations described herein.

Computer program code for carrying out operations of data processing systems discussed above with respect to FIG. 2 may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

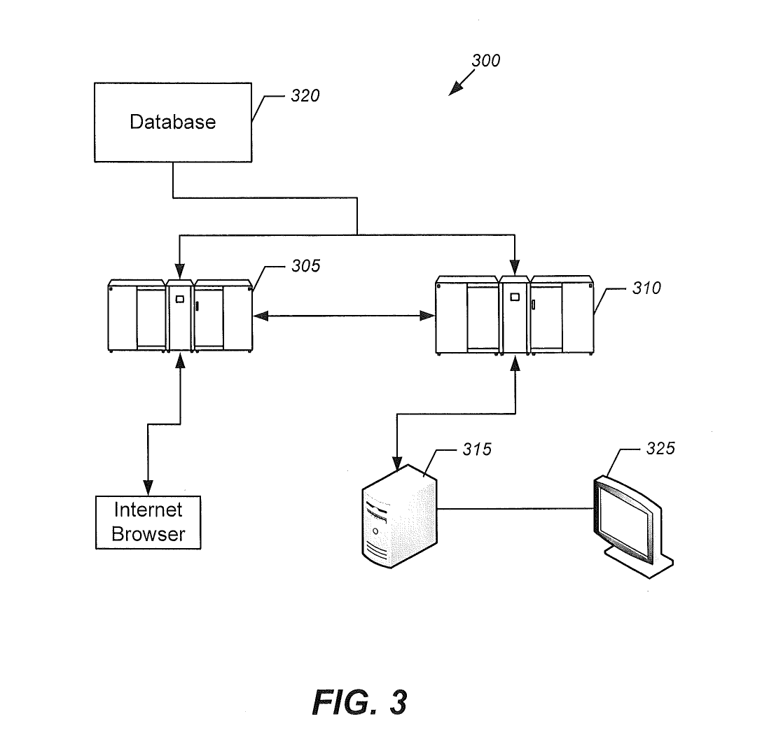

FIG. 3 is a block diagram that illustrates a communication network 300 for publishing a media presentation for digital signage in accordance with some embodiments of the present invention. As shown in FIG. 3, the communication network 300 comprises a portal server for generating a media presentation for digital signage 305, a digital signage distribution server 310, a media player 315, and a content storage database 320 for saved content. The portal server 305 may provide tools that are configured to facilitate the creation of templates specify how content is displayed in various zones of a display and to populate those templates with content to create instantiated templates. A user may access these tools, through, for example, an Internet browser. The content can be uploaded by a user and/or may be selected from the content storage database 320. The portal server 305 may be implemented, for example, using the data processing systems of FIGS. 1 and 2.

The portal server 305 may communicate with the digital signage distribution server 310 to communicate playlist information comprising one or more instantiated templates, client images, screen layout information fader/ticker messages, and the like. The digital signage distribution server 310 may inform the portal server of the status of any transaction requests. The digital signage distribution server 310 may also receive media files, such as video files, static images, text information, and the like from the content storage database 320.

The digital signage distribution server 310 communicates with one or more media players 315, which comprise a destination display platform for presenting digital signage to, for example, customers, patients, guests, or other consumers that may have interest in the information presented. In some embodiments, the digital signage distribution server 310 may be implemented via a third party service provider that is separate from the party providing the portal server 305 in which the functionality of the signage distribution server 310 is provided to the party associated with the portal server 305 as software as a service (SaaS).

It will be appreciated that the portal server 305 may be implemented as a single server, separate servers, or a network of servers either co-located in a server farm, for example, or located in different geographic regions.

Although FIG. 3 illustrates an exemplary communication network for generating a media presentation for digital signage in accordance with some embodiments of the present invention, it will be understood that the present invention is not limited to such a configuration but is intended to encompass any configuration capable of carrying out operations described herein.

The present invention is described herein with reference to flowchart, information flow, and/or block diagram illustrations of methods, systems, and computer program products in accordance with exemplary embodiments of the invention. These flowchart, information flow, and/or block diagrams further illustrate exemplary operations for generating a media presentation for digital signage, in accordance with some embodiments of the present invention. It will be understood that each block of the flowchart, information flow, and/or block diagram illustrations, and combinations of blocks in the flowchart, information flow, and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart, information flow, and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart, information flow, and/or block diagram block or blocks.

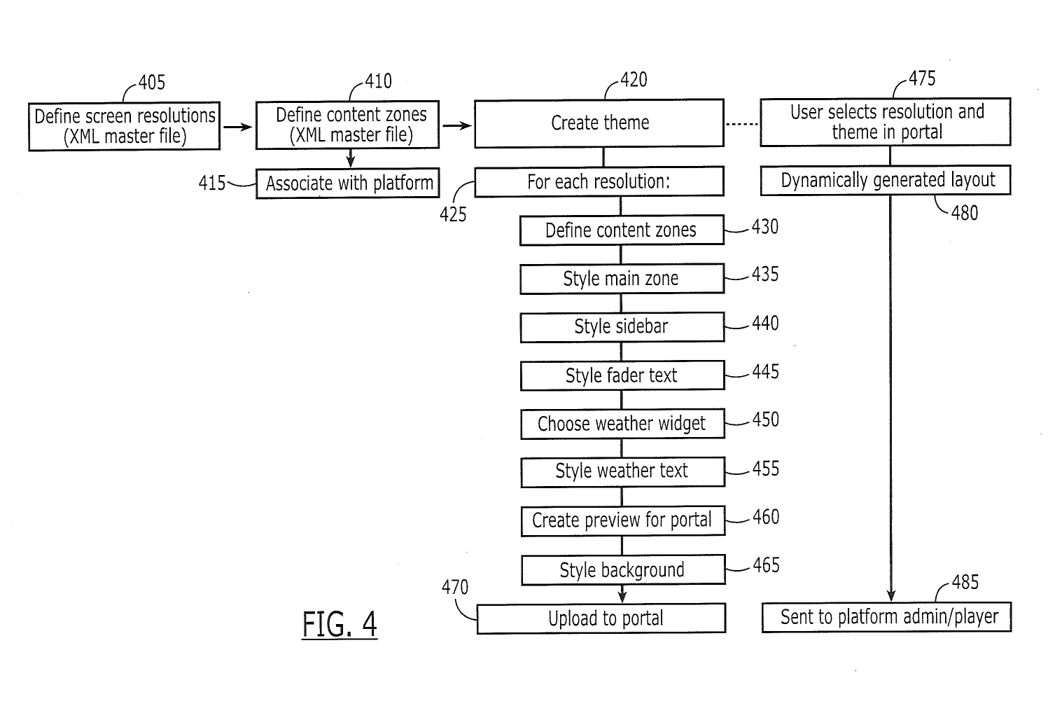

Referring now to FIGS. 4-6, exemplary operations for generating a media presentation for digital signage using, for example, the portal server 305 of FIG. 3, in accordance with some embodiments of the present invention, will now be described. FIG. 4 is a flow diagram that illustrates the generation of display elements that provide a framework for a media presentation for digital signage. At block 405, a master list of supported screen resolutions is defined. These screen resolutions may be dependent on the particulars design of the media presentation including the number and type of content zones as well as the instantiated templates used in the various content zones. At block 410 at list of content zones is defined, which can be populated with content by the user or the portal server 305 may provide specific content for standard content zones, e.g., a weather content zone, stock price content zone, etc. The content zones are associated with a destination display platform at block 415.

Themes that define the look and feel of the media presentation are created at block 420. At block 425, for each resolution defined at block 405, a theme is defined for each of the content zones at block 430. Styles may be defined for a main content zone, sidebar content zone, fader zone, e.g., a scrolling ticker zone at blocks 435, 440, and 445, respectively. A widget for providing weather data is defined at block 450 and a style for presenting the weather information is defined at block 455. A preview for the media presentation is defined at block 460 and a background style is defined at block 465. The theme may be comprise a variety of related files, such as CSS files, PHP files, images, fonts, etc. that can be uploaded to the portal server 305 at block 470. The files used to implement the theme are dependent on the number and type of content zones used and the particular look and feel desired for the media presentation.

Multiple themes can be created and a user may select a screen resolution along with a theme to be used for a media presentation at block 475. The user may then create templates that include pages for various content zones, such as the main content zone and one or more sidebar content zones at block 480 as will be described in more detail below. The templates may then be populated with content to create instantiated templates that can be then compiled into a playlist and communicated to the signage distribution server 310, which sends the playlist to the destination display platform at block 485 for display on one of more display devices.

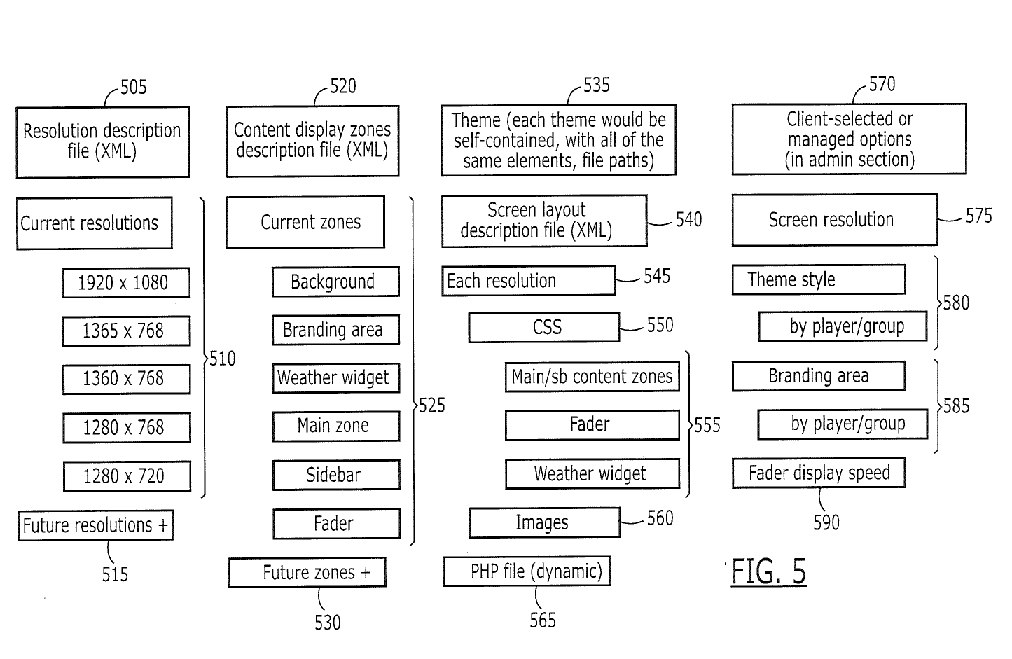

FIG. 5 is a block diagram that provides more detail on the various display elements of FIG. 4 according to some embodiments of the present invention. The screen resolution file at block 505 may include a plurality of currently supported screen resolutions 510 for a user to select from as shown with the ability to add future screen resolutions 515 as desired and supported by display technology.

The content display zones 520 includes a list of currently used zones 525, which are a background zone, branding area zone, weather widget zone, main zone, sidebar zone, and fader zone. These zones are merely exemplary and more, fewer, or different zones may be used in accordance with various embodiments of the present invention. The background zone refers to the display zone on which the other zones are overlayed. The branding area zone is a display zone that can be used to present a particular logo, phrase, or the like that is associated with the party presenting the content. The weather widget zone is a zone that may provide weather data. The main zone is a primary zone that is used to display information that has been customized both in content and format through use of user designed templates as described in detail below. The sidebar zone is similar to the primary zone, but may receive a less prominent position on the display screen. The fader zone is similar to a ticker or scroll bar that may allow instant messages to be communicated or may communicate information that frequently changes, such as stock price information, for example. Additional zones may be added or existing zones may be deleted at block 530.

As described above, a theme at block 535 includes a variety of related files, such as CSS files, PHP files, images, fonts, etc. that are used to provide the look and feel for a media presentation. The theme includes an XML screen layout description file 540 and, for each resolution, CSS files 550 for various content zones 555 and any image files to be used. At block 565, PHP files can be dynamically generated based on the resolution used. A separate screen layout description file 540 is used for each resolution supported.

The user may select particular display elements at block 570, such as screen resolution 575, theme style 580 based on the destination display platform, i.e., the digital signage player/group of players, the branding area style 585 based on the destination display platform, and the fader display speed 590, i.e., the scroll speed. Options may include, but are not limited images, text font, color, style, size, and the like.

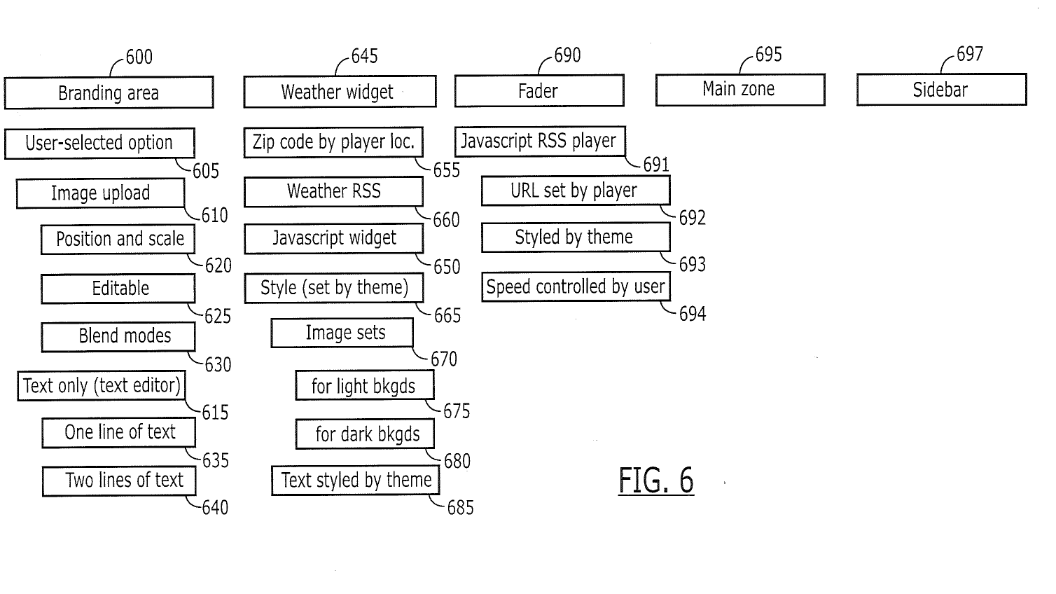

FIG. 6 is a block diagram that provides more detail on the various content zones of FIG. 4. The branding area zone 600 may provide the user with a choice at block 605 at using an image for branding 610, using text for branding, or both. The branding image may be positioned/scaled 620, edited 625, and/or blended to enhance its appearance, e.g., darkened, lightened, etc. The text editor 615 may be used to provide a single line of text 635 or multiple lines of text 640 for branding purposes.

The weather widget 645 may be implemented through a Javascript widget and the weather information may be based on a zip code 655, for example, of the particular display that the presentation is running on. The weather data may be obtained through a weather RSS feed 660 with style information 665 including image sets 670 for light 675 and dark 680 backgrounds. The text style 685 may also be based on the theme used.

The fader zone 690 may be implemented via a Javascript RSS player 691 with the URL set by the player 692 that is running the media presentation for the digital signage. The style of the fader may be based on the theme used with the user selecting the speed at which messages scroll across the fader zone 694.

The main and sidebar zones 695 and 697 are designed and populated with content by the user with their style being based on the theme selected. The layout of information within the main and sidebar zones 695 and 697 is based on the layout of pages that comprise the instantiated templates that are displayed in the main an sidebar zones 695 and 697.

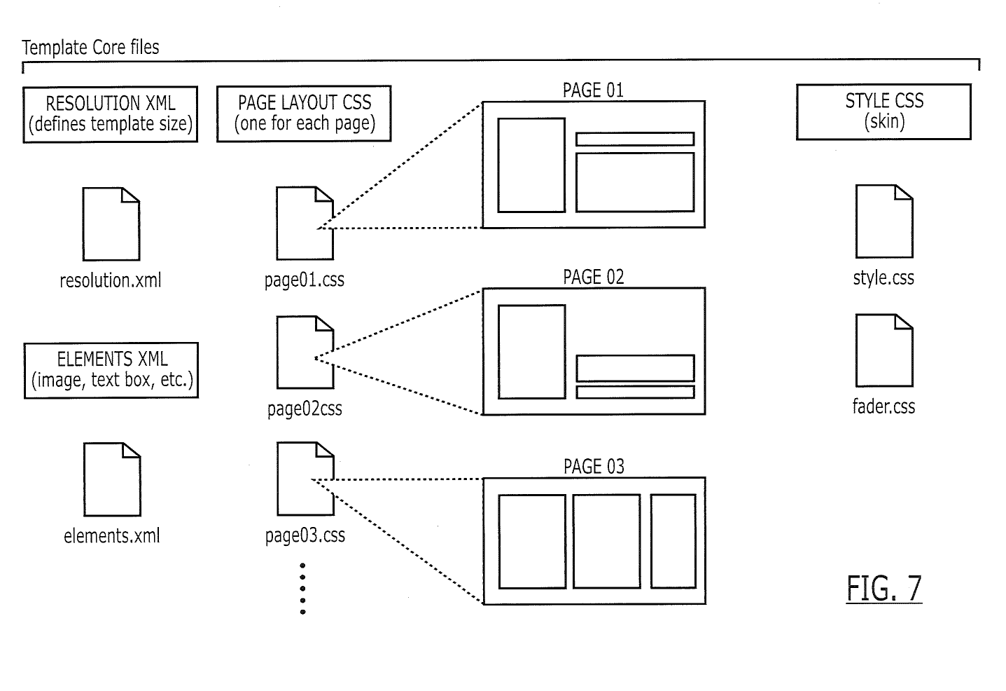

FIG. 7 is a block diagram that illustrates a template for use in a media presentation for digital signage in accordance with some embodiments of the present invention. A template is used to define the framework for presenting content in either the main or sidebar content zones. In the example shown in FIG. 7, a template includes three pages (PAGE 01, PAGE 02, PAGE 03) which are used to display information. Each page includes an arrangement of windows that can be populated with content. Each page is defined by an associated CSS file, which specifies the positions of the various windows therein, sets basic text formatting, and the like. A resolution file defines the template size and an elements file provides various images, text boxes, and the like. A skin may be provided that includes a style CSS to define the overall look of the template and a fader CSS to define the styling for any fader that is used with the template.

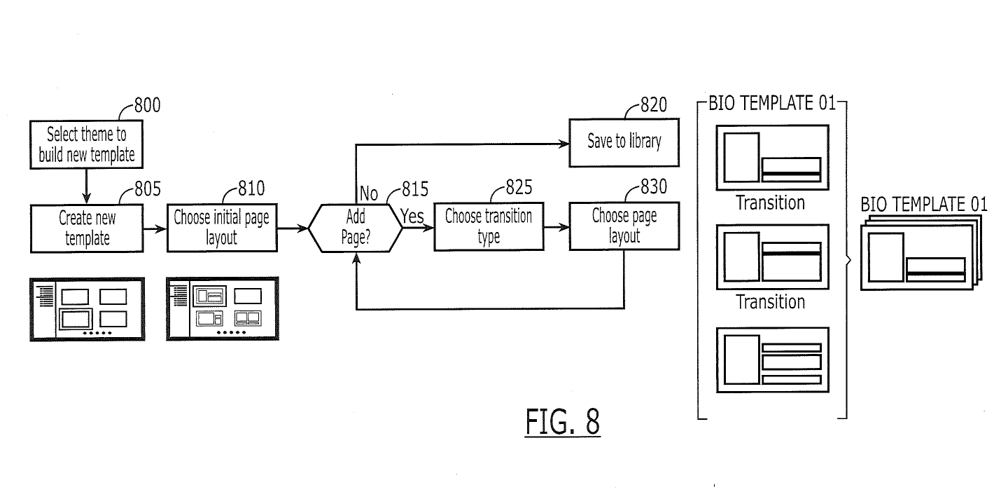

FIG. 8 is a flowchart for creating a template for use in a media presentation for digital signage in accordance with some embodiments of the present invention. Operations begin at block 800 where a user selects a theme for the new template. At block 805 a new template is created and the user determines whether the template is associated with the main content zone or a sidebar content zone. Based on which content zone the template is being designed for, a duration of how long to display each page may be selected. At block 810, the user may select a page layout by browsing available page layouts provided on the portal server 305. These different page layouts may provide a wide variety of different window configurations and layouts that can be populated with content. A determination is made at block 815 whether the template will be a single page template or whether to add additional pages to the template. If the user does not desire to add any additional pages to the template, the template is saved on the portal server 305 at block 820. If, however, an additional page is to be added, then a transition type is selected at block 825, which defines how one page transitions to another on the display screen. At block 830 the user browses the available page layouts provided on the portal server 305 to select a second page layout and the page is added to the template. If no additional pages are to be added to the template, then the template is saved at block 820. Otherwise, the operations continue until the user has created all the pages desired for a particular template. In the example shown in FIG. 8, a BIO TEMPLATE 01 is created with three pages.

In other embodiments of the present invention, only a single page layout option may be provided in which case the operations associated with blocks 810 and 830 are unnecessary.

The user may select individual times for each page to be displayed or an overall time for displaying the entire template in which case the portal server 305 may specify that the overall time is divided equally over the individual pages comprising the template.

The portal server 305 may also provide master templates for conveying common information that a user may select for playing on a destination display platform.

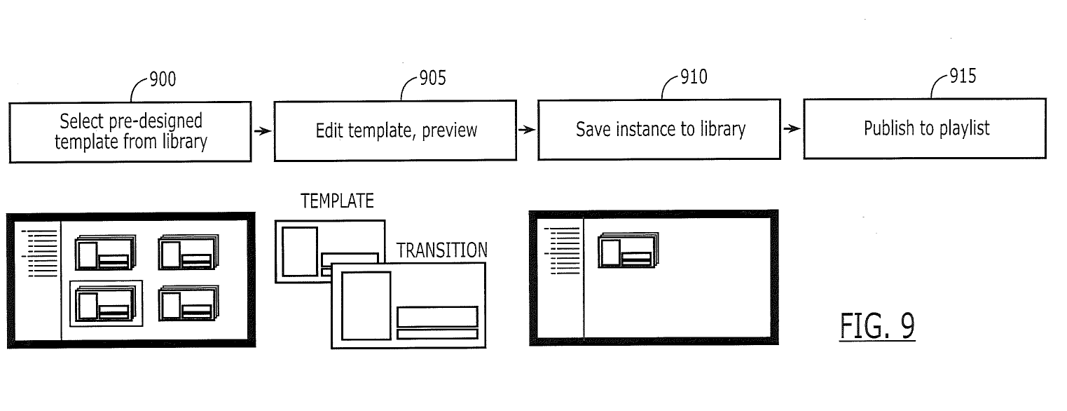

FIG. 9 is a flow diagram that illustrates adding content to a template to create an instantiated template and publishing the instantiated template in accordance with some embodiments of the present invention. Operations begin at block 900 where a user selects a pre-designed template that has been saved on the portal server 305. The template may be on that the user designed or may be one that is provided by the portal server 305 that contains general information on topics of interest or templates provided by other users of the portal server 305 that the creator is willing to share with others. The user may then edit the selected template to populate the windows of the pages with content, which may include text, images, video, and the like. Once each page of the template has been populated with content, the template is saved to a storage location associated with the portal server 305 as an instantiated template. Just as templates may be shared with others users, instantiated templates, which are populated with content, may also be shared with other users. A default is typically that the instantiated template is private to the user that created it.

The user may then publish an instantiated template to a playlist that can be communicated to the digital signage distribution server 310, which communicates with one or more media players 315 that comprise a destination display platform for presenting digital signage. The playlist may have start and end dates associated therewith and the user may also be able to control the particular frequency with which the playlist is run on the destination display platform, such as particular days, times, how often it repeats, whether it runs in a continuous loop, etc. Advertisements may be inserted between presentations of a playlist, which may reduce user costs as the advertisement time and space may be sold to other parties.

The flowcharts/flow diagrams of FIGS. 4-9 illustrates the architecture, functionality, and operations of some embodiments of systems, methods, and computer program products for generating a media presentation for digital signage in accordance with some embodiments of the present invention. In this regard, each block represents a module, segment, or portion of code, which comprises one or more executable instructions for implementing the specified logical function(s). It should also be noted that in other implementations, the function(s) noted in the blocks may occur out of the order noted in FIGS. 4-9. For example, two blocks shown in succession may, in fact, be executed substantially concurrently or the blocks may sometimes be executed in the reverse order, depending on the functionality involved.

Embodiments of the present invention may be illustrated by way of example. A medical practice may use the portal server 305 described herein to create instantiated templates that include information about current medical topics, treatments, products, etc., that may be of interest to its patients. These instantiated templates may be published to a digital signage display platform with displays in various waiting rooms associated with the medical practice to allow patients to watch/read the content while they wait for their appointments. This may generate increased purchases of medical products from the practice and/or may provide helpful information to improve the health of the patients being treated. The medical practice may also sell time/space on the display for advertisements that can alleviate some of the cost of developing and maintaining the content conveyed through the digital signage. Thus, embodiments of the present invention may provide a set of tools and methodologies that can allow user to design and update digital signage content themselves with reduced cost and technological complexity.

Many variations and modifications can be made to the preferred embodiments without substantially departing from the principles of the present invention. All such variations and modifications are intended to be included herein within the scope of the present invention, as set forth in the following claims.

That which is claimed:

1. A method of generating a media presentation, comprising:
receiving a request to create a template, the template comprising a page;
receiving a selection of a layout from a plurality of layouts for the page, the layout specifying positions of display windows on the page; and
saving the template.

2. The method of claim 1, wherein the page is a first page, the method further comprising:
receiving a request to add a second page to the template;
receiving a selection of a layout from the plurality of layouts for the second page; and
saving the template, which comprises the first and second pages.

3. The method of claim 2, further comprising:
receiving a selection of a transition type that specifies how a display transitions between displaying the first page and the second page.

4. The method of claim 1, further comprising:
defining a plurality of content zones for a display.

5. The method of claim 4, wherein the plurality of content zones comprise a branding zone, a weather zone, a fader zone, a main zone, and a sidebar zone.

6. The method of claim 5, wherein the template is associated with the main content zone on a display.

7. The method of claim 5, wherein the template is associated with a sidebar content zone on a display.

8. The method of claim 1, further comprising:
receiving a selection of a saved template from a plurality of saved templates;
adding content to the saved template to create an instantiated template; and
saving the instantiated template.

9. The method of claim 8, wherein adding content to the saved template comprises:
receiving the content from a user.

10. The method of claim 8, wherein adding content to the saved template comprises:
receiving a selection of stored content.

11. The method of claim 8, further comprising:
publishing the instantiated template for presentation on at least one display.

12. The method of claim 11, wherein publishing the instantiated template comprises:
receiving a selection of a frequency for which the instantiated template is presented on the at least one display.

13. The method of claim 8, wherein saving the instantiated template comprises:
receiving sharing privileges for the instantiated template that indicates who can access the instantiated template.

14. A system for generating a media presentation, comprising:
a processor configured to receive a request to create a template, the template comprising a page, receive a selection of a layout from a plurality of layouts for the page, the layout specifying positions of display windows on the page, and save the template.

15. The system of claim 14, wherein the page is a first page, the processor being further configured to receive a request to add a second page to the template, receive a selection of a layout from the plurality of layouts for the second page, and save the template, which comprises the first and second pages.

16. The system of claim 15, wherein the processor is further configured to receive a selection of a transition type that specifies how a display transitions between displaying the first page and the second page.

17. The system of claim 14, wherein the processor is further configured to define a plurality of content zones for a display.

18. The system of claim 17, wherein the plurality of content zones comprise a branding zone, a weather zone, a fader zone, a main zone, and a sidebar zone.

19. The system of claim 18, wherein the template is associated with the main content zone on a display.

20. The system of claim 18, wherein the template is associated with a sidebar content zone on a display.

21. The system of claim 14, wherein the processor is further configured to receive a selection of a saved template from a plurality of saved templates, add content to the saved template to create an instantiated template, and save the instantiated template.

22. The system of claim 21, wherein the processor is configured to add content to the saved template by receiving the content from a user.

23. The system of claim 21, wherein the processor is configured to add content to the saved template by receiving a selection of stored content.

24. The system of claim 21, wherein the processor is further configured to publish the instantiated template for presentation on at least one display.

25. The system of claim 24, wherein the processor is configured to publish the instantiated template by receiving a selection of a frequency for which the instantiated template is presented on the at least one display.

26. The system of claim 21, wherein the processor is configured to save the instantiated template by receiving sharing privileges for the instantiated template that indicates who can access the instantiated template.

27. A computer program product for generating a media presentation, comprising:
a non-transitory computer readable storage medium having computer readable program code embodied therein, the computer readable program code comprising:
computer readable program code configured to receive a request to create a template, the template comprising a page;
computer readable program code configured to receive a selection of a layout from a plurality of layouts for the page, the layout specifying positions of display windows on the page; and
computer readable program code configured to save the template.

28. The computer program product of claim 27, wherein the page is a first page, the computer readable program code further comprising:
computer readable program code configured to receive a request to add a second page to the template;
computer readable program code configured to receive a selection of a layout from the plurality of layouts for the second page; and
computer readable program code configured to save the template, which comprises the first and second pages.

29. The computer program product of claim 28, further comprising:
computer readable program code configured to receive a selection of a transition type that specifies how a display transitions between displaying the first page and the second page.

30. The computer program product of claim 27, further comprising:
computer readable program code configured to define a plurality of content zones for a display.

31. The computer program product of claim 30, wherein the plurality of content zones comprise a branding zone, a weather zone, a fader zone, a main zone, and a sidebar zone.

32. The computer program product of claim 31, wherein the template is associated with the main content zone on a display.

33. The computer program product of claim 31, wherein the template is associated with a sidebar content zone on a display.

34. The computer program product of claim 27, further comprising:
computer readable program code configured to receive a selection of a saved template from a plurality of saved templates;
computer readable program code configured to add content to the saved template to create an instantiated template; and
computer readable program code configured to save the instantiated template.

35. The computer program product of claim 34, wherein the computer readable program code configured to add content to the saved template comprises:
computer readable program code configured to receive the content from a user.

36. The computer program product of claim 34, wherein the computer readable program code configured to add content to the saved template comprises:
computer readable program code configured to receive a selection of stored content.

37. The computer program product of claim 34, further comprising:
computer readable program code configured to publish the instantiated template for presentation on at least one display.

38. The computer program product of claim 37, wherein the computer readable program code configured to publish the instantiated template comprises:
computer readable program code configured to receive a selection of a frequency for which the instantiated template is presented on the at least one display.

39. The computer program product of claim 34, wherein the computer readable program code configured to save the instantiated template comprises:
computer readable program code configured to receive sharing privileges for the instantiated template that indicates who can access the instantiated template.
